(19) United States
(12) Patent Application Publication
(10) Pub. No.: US 2017/0371352 A1
(43) Pub. Date: Dec. 28, 2017

(54) METHOD FOR DYNAMICALLY CONVERTING THE ATTITUDE OF A ROTARY-WING DRONE

(71) Applicant: PARROT DRONES, Paris (FR)

(72) Inventors: Marc Mari Mari, Paris (FR); Yoni BENATAR, Les Lilas (FR)

(21) Appl. No.: 15/635,138

(22) Filed: Jun. 27, 2017

(30) Foreign Application Priority Data
Jun. 27, 2016 (FR) 1655986

(51) Int. Cl. G05D 1/08; B64C 29/02; B64C 39/02

(52) U.S. Cl. CPC G05D 1/0858; B64C 39/024; B64C 29/02; B64C 2201/104; B64C 2201/108; B64C 2201/042

(57) ABSTRACT

A method for dynamically converting the attitude of a rotary-wing drone that includes a body including an electronic board controlling the piloting of the drone and four link arms forming lift-producing wings, each arm including a rigidly connected propulsion unit. The method includes executing, on reception of an instruction allowing a conversion between flight using the rotary wings and flight using the lift of the wings, the conversion being defined by a pitch angle to be achieved θ_{ref}, of a repeated sequence of steps until the pitch angle θ_{ref} is achieved, including estimating the current pitch angle θₑₛₜ of the drone, determining an angular trajectory depending on the pitch angle to be achieved θ_{ref}, and sending one or more differentiated commands based upon the angular trajectory and the current estimated pitch angle θₑₛₜ to one or more propulsion units such that the drone is rotated about the pitch axis.

### CROSS REFERENCE TO RELATED APPLICATIONS

This application claims priority under 35 U.S.C. §119(a) to French Patent Application Serial Number 1655986, filed Jun. 27, 2016, the entire teachings of which are incorporated herein by reference.

### BACKGROUND OF THE INVENTION

### Field of the Invention

The invention relates to leisure drones, in particular rotary-wing drones such as quadcopters and similar.

### Background of the Invention

Flying drones include a drone body and one or more propulsion units mounted at the end of link arms, each propulsion unit being provided with a propeller driven by an individual motor. The different motors can be controlled in a differentiated manner in order to control the attitude and speed of the drone. An example is the ROLLING SPIDER™ marketed by Parrot Drones SAS, Paris, France.

Quadcopters are provided with four propulsion units each equipped with a propeller. The propellers on two propulsion units rotate in the clockwise direction and the propellers on the other two propulsion units rotate in the anti-clockwise direction. The propulsion units equipped with propellers rotating in the same direction of rotation are positioned on the same diagonal line. Each propeller exerts traction on the drone owing to the lift of the propeller, this traction being directed upwards, and a torque which is in the opposite direction to the direction of rotation of said propeller.

Patent Cooperation Treaty Published Patent Application WO 2010/061099 A2 and European Published Patent Applications EP 2 364 757 A1 and EP 2 450 862 A1 (Parrot) describe the principle of piloting a drone by means of a multimedia telephone or tablet having a touch screen and integrated accelerometers, for example a smartphone or a tablet computer.

There are four commands issued by the piloting device, namely roll, i.e. the rotational movement about its longitudinal axis, pitch, i.e. the rotational movement about the transverse axis, yaw, also known as heading, i.e. the direction in which the drone is oriented, and vertical acceleration.

When a yaw command is sent to the drone, the propulsion units that have propellers rotating in one direction rotate faster, i.e. the propulsion units accelerate, whereas the other two propulsion units rotate less quickly.

In this way, the sum of the lift forces compensates for the weight of the drone, but the sum of the torques is no longer zero and the drone therefore turns onto a yaw. Turning the drone to the right or the left onto a yaw depends on the two diagonal propulsion units that are required to accelerate their rotation.

When a pitch command is sent to the drone, the propulsion units situated in the direction of the drone are slowed down and the propulsion units situated to the rear relative to the direction of movement of the drone are accelerated.

When a roll command is sent to the drone, the propulsion units situated in the desired direction of rotation of the drone are slowed down and the propulsion units situated on the opposite side are accelerated.

However, this type of drone is limited in its application, as it only allows quadcopter flight, i.e. using rotary wings.

In the field of scale models, a number of aircraft-type flying devices are known which do not allow flight by lift and rotary-wing propulsion, but flight assured by a thruster and for which lift is provided by the lift-producing wings of said aircraft. The aircraft are therefore considered fixed-wing apparatuses.

However, it is noted that said scale models are difficult to pilot and are often subject to crashes that damage the scale model.

### SUMMARY OF THE INVENTION

The object of the invention is to propose a rotary-wing drone that allows a drone of this kind to fly not only using the lift of the rotational surfaces, namely the rotary wings, but also to fly like an aircraft using a fixed wing, while benefiting from the easy control offered nowadays by drones. To do this, the drone flying conventionally using the rotary wings has to effect a conversion so as to fly using the fixed wing of the drone.

Accordingly, the invention proposes a method for dynamically converting the attitude of a rotary-wing drone comprising a drone body that comprises an electronic board controlling the piloting of the drone, and four link arms, each arm comprising a rigidly connected propulsion unit.

In a characteristic manner, since the link arms form lift-producing wings, the method comprises executing, on reception of a flight conversion instruction which allows the drone to effect a flight conversion between flight using the rotary wings and flight using, at least in part, the lift of the wings, said conversion being defined by a pitch angle to be achieved δ_{ref}, a repeated sequence of steps until said pitch angle θ_{ref} is achieved:
estimating the current pitch angle θₑₛₜ of said drone,
determining an angular trajectory depending on the pitch angle to be achieved θ_{ref},
sending one or more differentiated commands to one or more propulsion units so as to produce a rotation of the drone about the pitch axis, which commands are servo-controlled by the angular trajectory and the current estimated pitch angle θₑₛₜ.

According to various subsidiary characteristics, taken alone or in combination:
the conversion instruction includes the pitch angle to be achieved θ_{ref},
the angular trajectory is a target trajectory in terms of angular acceleration and/or angular velocity and/or angle,
the step of estimating the current pitch angle θₑₛₜ of said drone is performed on the basis of the measurement of the angular velocity of the drone,

The method may also include a step of determining an anticipatory pre-command on the basis of the angular trajectory and the estimated current pitch angle.

On the basis of the angular trajectory that has been determined and the anticipatory pre-command, the method further comprises generating set values corresponding to an angular position at the given instant and applying said set values to a servo-control loop controlling the motors of the drone. In this regard, the set values may be set values for the angle of inclination of the drone relative to the pitch axis thereof.

The method may yet further include the following steps:
determining the altitude of said drone prior to executing the conversion instruction,
estimating the current altitude of the drone,
determining a trajectory in terms of altitude and vertical velocity depending on the altitude prior to executing the conversion instruction,
sending one or more differentiated commands to one or more propulsion units so as to produce a correction in the altitude of the drone, servo-controlled to the trajectory in terms of altitude and vertical velocity and the estimated current altitude.

The drone may even yet further include a battery unit, and the method may then further include a step of measuring the voltage of said battery unit and the differentiated command/s are further determined on the basis of the measured voltage of said battery unit.

As well, the drone may even yet further include at least one ultrasonic sensor, and the method may further include a step of activating/deactivating the ultrasonic sensor.

Of note, during a flight conversion between flight using the rotary wings and flight using, at least in part, the lift of the wings, the method may further include a prior step of reducing the maximum angular velocity on the pitch axis and/or the maximum angular velocity on the roll axis.

As well, during a flight conversion between flight, the pitch angle to be achieved is substantially zero in using, at least in part, the lift of the wings and flight using the rotary wings.

The invention also relates to a rotary-wing drone that includes a drone body that includes an electronic board controlling the piloting of the drone, and four link arms, each arm comprising a rigidly connected propulsion unit. The link arms form lift-producing wings and the drone is suitable for implementing the method for dynamic control described above.

The invention also relates to an assembly that includes a control device for a rotary-wing drone and a rotary-wing drone as described above, the control device also comprises a set of piloting instructions, and one instruction of said instruction set is an instruction to convert the flight of the drone in order to effect a conversion between rotary-wing flight and flight using the lift of the wings.

According to a particular embodiment, when there is a conversion instruction between flight using the rotary wings and flight using, at least in part, the lift of the wings, the conversion instruction comprises a pitch angle to be achieved θ_{ref}.

### BRIEF DESCRIPTION OF THE DRAWINGS

An embodiment of the present invention will now be described with reference to the accompanying drawings.

FIG. 1 is a general view of the drone according to the invention seen from above when the drone is on the ground.

FIG. 2 is a side view of the drone according to the invention when the drone is in flight using the lift of the wings.

FIG. 3 is a view from above of the drone according to the invention when the drone is in flight using the lift of the wings.

FIG. 4 is a rear view of the drone according to the invention when the drone is in flight using the lift of the wings.

FIG. 5 is a state diagram of the steps prior to the dynamic conversion of the drone.

FIG. 6 is a state diagram of the dynamic conversion of the drone according to the invention.

FIG. 7 is a block diagram of the different control and servo-control components and dynamic conversion components of a rotary-wing drone according to the invention.

### DETAILED DESCRIPTION OF THE INVENTION

An embodiment of the invention will now be described.

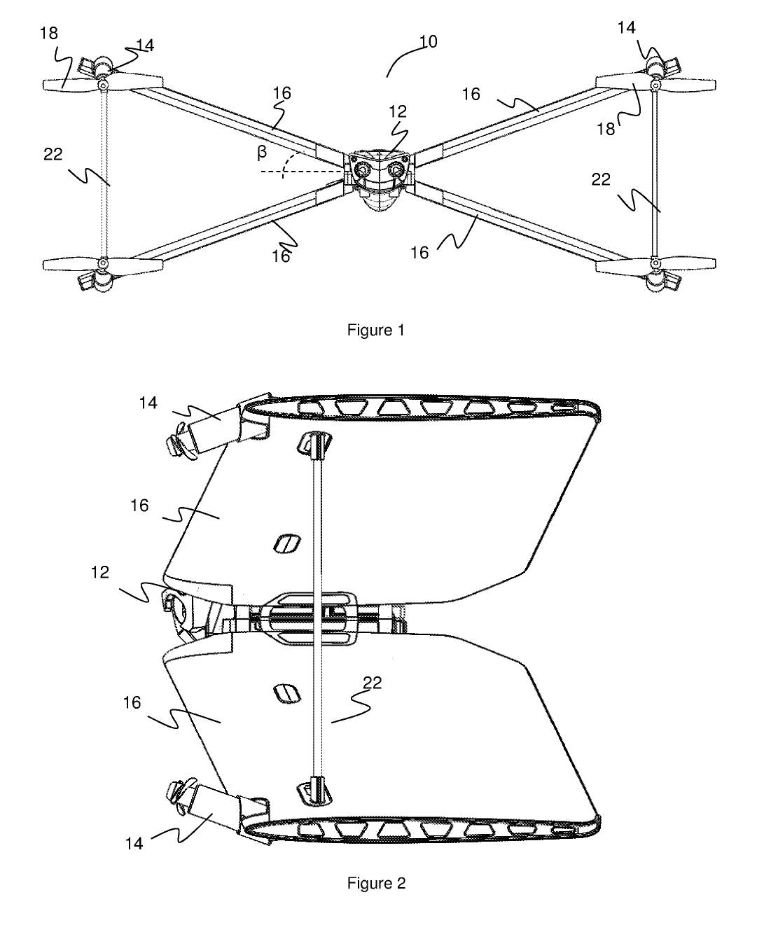

In FIG. 1, reference sign 10 generally designates a rotary-wing drone. In the example shown in FIG. 1, it is a quadcopter-type drone derived from the Rolling Spider model marketed by Parrot Drones SAS, Paris, France.

The quadcopter drone includes a drone body 12 that comprises an electronic board controlling the piloting of the drone, and four propulsion units 14 rigidly connected to the four link arms 16, respectively. The propulsion units 14 are independently controlled by an integrated navigation and attitude control system. Each propulsion unit 14 is equipped with a propeller 18 driven by an individual motor. The different motors can be controlled in a differentiated manner in order to control the attitude and speed of the drone and with the production of positive lift.

The propellers 18 on two propulsion units rotate in the clockwise direction and the propellers on the other two propulsion units rotate in the anti-clockwise direction. The propulsion units equipped with propellers rotating in the same direction of rotation are positioned on the same diagonal line.

In a manner that is characteristic of the invention, the link arms 16 form lift-producing wings, substantially perpendicular to the plane of the propellers, allowing the drone to fly either using the rotary wings or in so-called aircraft flight, so as to benefit from the lift of the lift-producing wings.

According to a particular embodiment, the propulsion units are secured substantially to the end of the lift-producing wings as shown in FIG. 1.

Alternatively, the propulsion units may be secured over almost the entire length of the lift-producing wings, notably in the region of the leading edge of each of the wings; however a minimum distance between two adjacent propulsion units should be respected, and said distance should not be less than the sum of the radii of the two propellers on said adjacent propulsion units.

According to the invention, the drone includes flight conversion means allowing the drone to effect a conversion after take-off in quadcopter mode, i.e. using the lift of the rotational surfaces, so that the drone flies using the lift of the wings.

To do this, the drone effects a conversion of a given angle, namely a pitch angle of from for example 20° to 90°, and preferably a pitch angle D of between 20° and 80°, such that the drone benefits from the lift of the wings in order to fly. Thus, the drone is suitable for flying conventionally using the lift of the rotational surfaces or like an aircraft using the lift of the wings. This type of drone has the advantage of being suitable for flying like an aircraft, but allows good control of the flight speed, as said drone is also suitable for flying very slowly, notably if the conversion angle is a small angle.

If the drone is defined before take-off according to the three orthogonal axes X, Y and Z, said axes will then be named:
X axis, the roll axis which is defined by the fact that a rotation of the drone on this axis allows the drone to be moved to the right or to the left, and
Y axis, the pitch axis which is defined by the fact that a rotation of the drone on this axis allows the drone to be moved forwards or backwards,
Z axis, the yaw axis or heading axis, which is defined by the fact that a rotation of the drone on this axis has the effect of making the main axis of the drone pivot to the right or to the left; thus, the direction of forward movement of the drone.

Thus, the conversion can be defined by the fact that the Z axis of the drone, corresponding to the heading axis during drone flight in conventional mode, i.e. using the lift of the rotary wing, becomes the roll axis when the drone transitions into aircraft flight mode, i.e. using the fixed wing, in other words the lift of the wings.

The drone shown in FIG. 1 includes four link arms in the form of lift-producing wings; however, this type of drone could comprise more than four lift-producing wings.

According to a particular embodiment, the drone body 12 has an elongate shape, for example. According to this embodiment, the lift-producing wings of the drone are secured to the entire length or to a portion of the length of the drone body.

The drone shown in FIG. 1 is such that the lift-producing wings 16 are positioned on each side of the drone body defined by the horizontal median plane of the drone body 12 when the drone is in the aircraft flight position, and the lift-producing wings are symmetric and form a dihedral, for example.

According to another embodiment, the lift-producing wings on either side of the drone body may not be symmetric relative to said horizontal median plane of the drone body.

It can also be seen that the drone shown in FIG. 1 is such that the lift-producing wings 16 are situated on either side of the drone relative to the vertical median plane 12 when the drone is in the aircraft flight position and the lift-producing wings are symmetric.

According to another embodiment, the lift-producing wings on either side of the drone body may not be symmetric relative to said vertical median plane of the drone body.

The structure of the drone as shown in FIG. 1 is X-shaped having a positive dihedral angle on the upper wings relative to the horizontal median plane of the drone body when the drone is in the aircraft flight position, and a negative dihedral angle of the same value on the lower wings relative to said horizontal median plane. However, the drone may comprise positive and negative dihedral angles of different values.

For example, the positive dihedral angle on the upper wings is between 15° and 25°, and preferably 20°. Similarly, in accordance with the drone illustrated, the negative dihedral angle on the lower wings is between 15° and 25°, and preferably 20°.

As can be seen in FIG. 1, the lift-producing wings have a wingspan such that the lever arm between the centre of gravity of the drone and the propulsion unit allows stable flight in aircraft mode. In the example illustrated in FIG. 1, the wingspan is 30 cm.

Furthermore, the lift-producing wings have a lift surface appropriate for allowing the drone to fly in aircraft mode using the lift of the wings. The surface of the wings is determined so as to offer good lift without having a major impact on the flight performance of the drone in conventional flight.

As shown in FIG. 1, the lift-producing wings 16 of the drone form a sweep angle β relative to the drone body 12; the sweep angle β may be between 5° and 20°, and preferably approximately 10°.

According to a particular embodiment, each of the propulsion units (apart from the propellers) of the drone is in the same plane as the wing to which it is secured. In other words, each of the propellers on the propulsion units is on a plane that is substantially perpendicular to the plane of the lift surface of the wing to which the propeller is secured.

However, according to the embodiment illustrated in FIG. 1 and in FIG. 4, the four propulsion units form an angle of inclination relative to the horizontal median plane of the drone body, the two propulsion units positioned on one side of the drone body each being inclined towards one another at a predetermined positive vertical angle of inclination and a predetermined negative vertical angle of inclination. Symmetrically, the two propulsion units positioned on the other side of the drone body are each inclined towards one another at the same predetermined positive vertical angle of inclination and the same predetermined negative vertical angle of inclination.

In other words, the propulsion units situated on either side of the drone body above the horizontal median plane of the drone body, when the drone is in the aircraft flight position, are each inclined towards the propulsion units situated on the same side of the drone body below said horizontal median plane, and vice versa. The propulsion units situated on either side of the drone body below said horizontal median plane are in particular each inclined towards the propulsion units situated on the same side of the drone body above the horizontal median plane.

The inclination of the propulsion units allows, in aircraft mode, a traction component to be created that is perpendicular to the horizontal direction of forward movement which contributes to increasing the available torque on the heading axis of the drone, which otherwise would result only from the torque of the propellers on the drone. This increase in torque may have an advantage for flight in aircraft mode, i.e. using the lift of the wings of the drone. This is because the increase in torque allows the displacement inertia of the drone to be counterbalanced on the heading axis in aircraft mode, which inertia is much greater than on a conventional drone, i.e. with no lift-producing wings, owing to the presence of lift-producing wings.

The inclination of the motors leads to a reduction in the lift that is generated, as only a portion of the traction produced by the motors is applied on the horizontal plane. However, as such inclination creates a perpendicular traction component, this contributes to increasing control of the drone on the heading axis in aircraft mode, as the application of a horizontal force on the lever arm that exists between the motors and the centre of gravity of the drone, optimised by placing propulsion units substantially at the ends of the wings, allows torque to be created on the heading axis which will be added to the torque of the propellers.

The traction needed for the drone to be able to fly in aircraft mode, i.e. using the lift of the wings, is less than the traction needed to allow the drone to maintain a fixed point in its conventional flight configuration, i.e. stationary flight.

It should also be noted that the Z axis of the drone, which corresponds to the heading axis when the drone flies in conventional mode, i.e. using the rotary wing, becomes the roll axis when the drone flies in aircraft mode, i.e. substantially horizontally using the lift of the wings.

According to a particular embodiment, the predetermined angles of inclination of the four propulsion units are identical as an absolute value.

However, according to another embodiment, the propulsion units situated above the horizontal median plane of the drone body, when the drone is in aircraft flight position, may have an angle of inclination as an absolute value that is different from the angles of inclination of the propulsion units situated below said horizontal median plane.

According to a particular embodiment, the predetermined angles of inclination are between 10° and 30°, and preferably about 20°.

It has been noted that the consequence of an angle of inclination of 20° as an absolute value applied to the propulsion units is losses of traction of approximately 6%. Moreover, the consequence of the circulation of the airflow around the wings when the motors rotate is an increase in the losses of traction owing to the inclination of the propulsion units. Thus, according to this embodiment, the losses of traction are approximately 24%.

According to a particular embodiment, the propulsion units may be substantially inclined so as to converge on the principal median axis of the drone and may therefore have an angle of inclination value relative to the vertical median plane of the drone body when the drone is in the aircraft flight position.

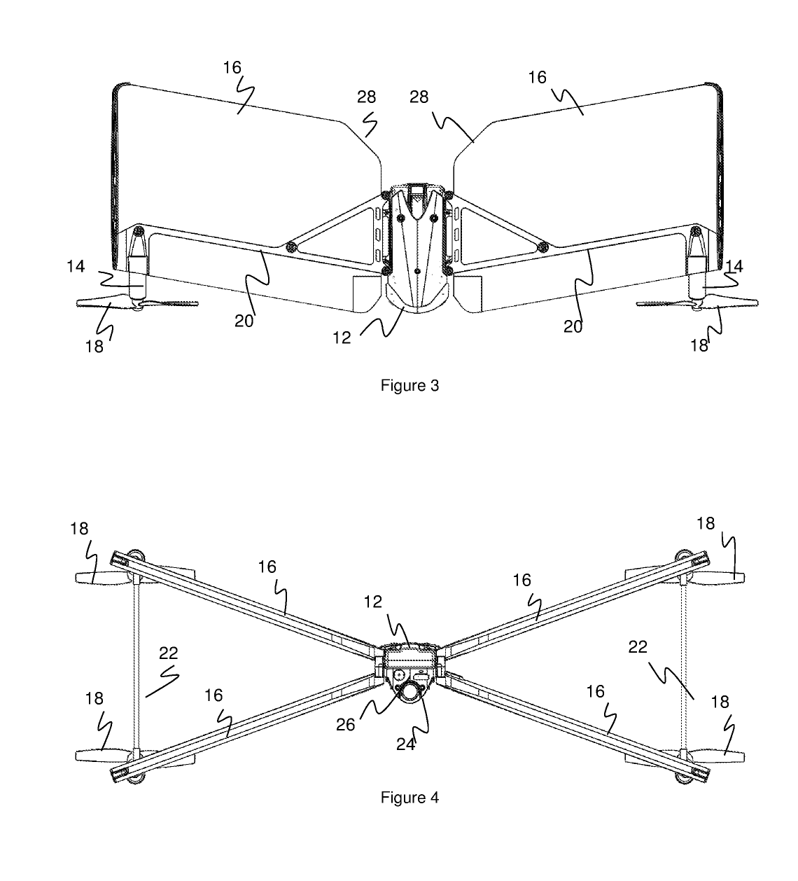

The drone illustrated in FIGS. 1, 2 and 3 comprises four lift-producing wings secured to the drone body, each wing having the shape of a parallelogram. However, other wing forms may be envisaged.

The lift-producing wings 16 may be connected to each other in pairs by at least one reinforcement means 22.

According to a particular embodiment, the lift-producing wings situated on the same side of the vertical median plane of the drone body, when the drone is in the aircraft flight position, are connected to each other by at least one reinforcement means 22 secured for example substantially close to the propulsion units. FIG. 1 shows an embodiment in which a single reinforcement means is secured between the lift-producing wings on the same side of the drone.

According to a particular embodiment of the drone, the wings may be provided with ailerons allowing the rotations of the drone to be controlled during flight in aircraft mode.

According to another particular embodiment, the drone may have no control surfaces such as aileron-type control surfaces. The movement of the drone in aircraft flight mode will in this case be controlled by controlling the rotational speed of the different propulsion units.

The drone is also equipped with inertial sensors (accelerometers or gyrometers) for measuring, to a particular degree of precision, the angular velocities and attitude angles of the drone, i.e. the Euler angles (pitch, roll and yaw) describing the inclination of the drone relative to a horizontal plane of a point of reference on the ground that is established before take-off, when the drone is switched on in accordance with the usual NED (north, east, down) convention, with the understanding that the two longitudinal and transverse components of the horizontal velocity are closely linked to the inclination along the two pitch and roll axes, respectively.

The drone 10 is controlled by a remote piloting device such as a multimedia telephone or tablet having a touch screen and integrated accelerometers, for example an iPhone-type (registered trade mark) or other mobile telephone, or an iPad-type (registered trade mark) or other tablet. This is a standard device that has not been modified except for the downloading of a custom software application in order to control the piloting of the drone 10. According to this embodiment, the user controls the movement of the drone 10 in real time using the piloting device.

The remote piloting device is an apparatus provided with a touch screen displaying a number of symbols allowing commands to be activated simply by a user touching the touch screen with their finger.

The piloting device communicates with the drone 10 via a bidirectional data exchange by means of a wireless local network such as Wi-Fi (IEEE 802.11) or Bluetooth (registered trade marks), namely from the drone 10 to the piloting device, in particular for transmitting flight data, and from the piloting device to the drone 10 for sending flying commands.

The piloting device is also provided with inclination sensors allowing the attitude of the drone to be controlled by sending commands depending on the roll, yaw and pitch axes in the reference point of the drone.

Whatever the flight mode of the drone, the piloting device has the same navigation symbols on the touch screen; however, the navigation commands issued to the drone will be analysed with regard to the real reference point of the drone.

Thus, the user pilots the drone directly, for example, by a combination of:
commands available on the touch screen, notably ‘ascent/descent’ and
signals emitted by the inclination detector of the apparatus: for example, to move the drone forwards the user tilts their apparatus along the corresponding pitch axis, and to turn the drone to the left or to the right they tilt said apparatus relative to the roll axis.

The touch screen also comprises one or more symbols for controlling the conversion of the drone from conventional flight mode, i.e. using the lift of the rotary wing, to aircraft flight mode, i.e. using the fixed wing, in other words the lift of the wings and vice versa.

Furthermore, the touch screen may comprise one or more symbols allowing a flight conversion of the drone from conventional flight mode to aircraft flight, but with the aircraft flying on its back.

Moreover, it may be possible to indicate on the touch screen the pitch angle for the desired conversion either directly or indirectly by selecting for example an aptitude level for flying in aircraft mode or by moving a cursor proportional to the desired pitch angle of the drone in aircraft mode.

According to another embodiment, the transition from conventional flight mode to aircraft flight mode is produced on the touch screen on the basis of a gearbox-type graphic interface component, where each level of the box corresponds to a particular pitch angle of the drone in aircraft mode.

In particular, said graphic interface component may take the form of a slider. In this embodiment, the drone user moves their finger over the slider to reach the first level. Each level of the graphic interface component corresponds to a pitch angle of the drone in aircraft mode. The drone user may then decide to modify the pitch angle of the drone to either a larger or smaller angle. To do this, the user may move the slider of the graphic interface component so as to select the higher level, in particular the second level, in order to increase the pitch angle of the drone.

In a particular embodiment, the graphic interface component comprises three levels corresponding to three different pitch angles of the drone, respectively, the first echelon corresponding to a small pitch angle while the third echelon corresponds to a large pitch angle.

The graphic interface component may also comprise a cursor around the level such that the current speed of the drone in aircraft flight mode can be changed.

To do this, on the basis of user instructions given by manipulation, for example, of the graphic interface component, piloting commands are issued to the drone in order to then determine the commands to be sent to the different propulsion units such that the drone is rotated about the pitch axis of the drone in accordance with the command from the user.

Said piloting command may comprise a pitch angle desired by the user, i.e. the pitch angle to be achieved θ_{ref}.

In order to allow the conversion command to be implemented by the drone, in particular, in order to dynamically convert the attitude of the drone, a method for dynamically converting attitude according to the invention is implemented, which will now be described.

The method as described below is the method for dynamically converting the attitude of a rotary-wing drone that is implemented on reception of a flight conversion instruction allowing the drone to effect a flight conversion between flight using the rotary-wing and flight using, at least in part, the lift of the wings. In other words, the method according to the invention allows a conversion of the drone from conventional flight mode to aircraft flight mode and a conversion of the drone from aircraft flight mode to conventional flight mode. In the first case, the pitch angle that the drone must achieve is indicated, and in the second case, the pitch angle is substantially zero, for example equal to 0°.

According to the invention, the conversion will be produced at a desired pitch angle θ_{ref}. In order to produce said conversion, the attitude of the drone is controlled by sending differentiated commands to one or more of said propulsion units 14 such that the drone is rotated about the pitch axis of the drone from a current angular position to a final angular position, said axes being defined in the reference point of the drone.

Thus, the conversion of the drone between flight using the rotary wings and flight using, at least in part, the lift of the wings, will be produced by sending differentiated commands to one or more of said propulsion units. The user will thus allow conversion of the flight mode of the drone by activating one or more piloting commands on the remote piloting device, said piloting commands causing a change in the rotational speed of the propulsion units.

In order to effect a coordinated conversion of the drone, according to an embodiment of the invention, the integrated navigation and attitude control system of the drone will execute a repeated sequence of steps until said pitch angle θ_{ref} is achieved. Said sequence comprises in particular i) estimating the current pitch angle θₑₛₜ of said drone on the basis of the measurement of the angular velocity of the drone, ii) determining an angular trajectory on the basis of the pitch angle to be achieved θ_{ref}, and iii) sending one or more differentiated commands to one or more propulsion units such that the drone is rotated about the pitch axis, which commands are servo-controlled to the angular trajectory and the estimated current pitch angle.

The angular trajectory is a target trajectory in terms of angular acceleration and/or angular velocity and/or as an angle.

The different steps of the method implemented in the drone to produce the dynamic conversion of the attitude of the drone, and in particular to determine the differentiated commands to be sent to one or more propulsion units of the drone, will now be described.

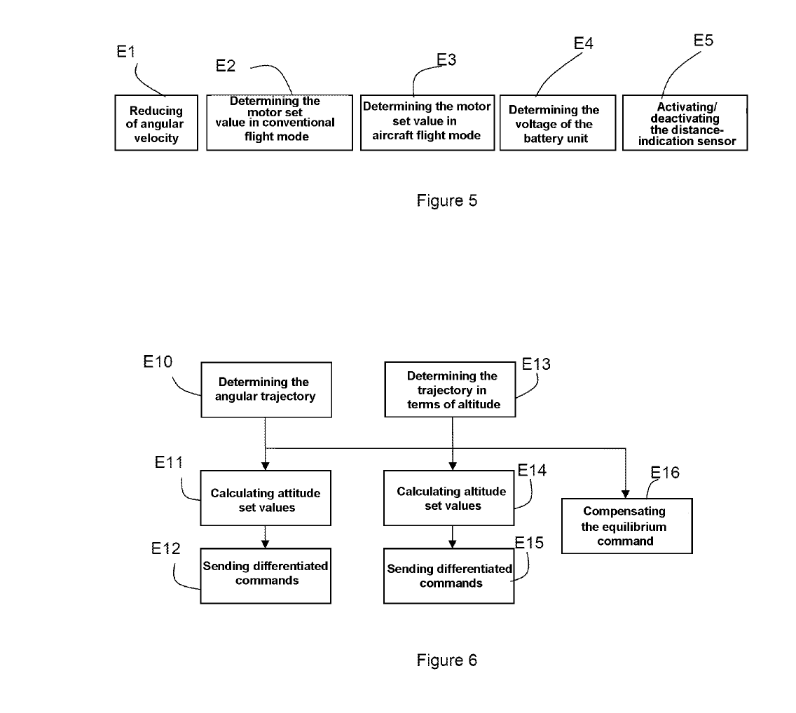

The method for dynamic conversion may comprise a first conversion preparation phase shown in FIG. 5.

The method comprises a step E1 implemented during a flight conversion between flight using the rotary-wing and flight using, at least in part, the lift of the wings. During this step, the method comprises reducing the maximum angular velocity on the pitch axis and/or the maximum angular velocity on the roll axis.

The method comprises a step E2 consisting of a step of determining the motor set values to be applied to the motor when the drone is in conventional flight mode when the pitch angle θ is zero or substantially zero.

The method comprises a step E3 consisting of a step of determining the motor set values to be applied to the motor when the drone is in aircraft flight mode when the pitch angle θ is zero or substantially zero.

The motor set values of step E2 and of step E3 are calculated, respectively, by a means for estimating the equilibrium of the drone in conventional flight and by an aerodynamic model of the drone (see below) describing the set values to be applied to the motors for each pitch angle of the drone in aircraft flight mode in order to maintain the aircraft at a constant altitude.

The method may also comprise a step E4 of determining the current value of the voltage of the battery unit of the drone.

During the conversion preparation phase, the method may comprise a step E5 which deactivates the use of the ultrasonic distance-indication sensor notably during a flight conversion of the drone from conventional flight mode using the lift of the propellers to aircraft flight mode using the lift of the wings. However, during a flight conversion of the drone from aircraft flight mode to conventional flight mode, step E5 activates the use of the ultrasonic distance-indication sensor.

In a particular embodiment, the deactivation of the ultrasonic distance-indication sensor is carried out only when the pitch angle of the drone is greater than a given threshold. In other words, when the angle of inclination of the drone relative to the horizontal is below a particular threshold, the ultrasonic distance-indication sensor is deactivated.

According to another embodiment, the ultrasonic distance-indication sensor is not deactivated, but the signal emitted by said sensor is taken into account only when the pitch angle of the drone is below a predetermined threshold, for example 45 degrees.

It should be noted that steps E1 to E5 may be executed sequentially. Similarly, steps E1 to E5 may be carried out in parallel with each other, as shown in FIG. 5.

The method continues with a sequence of steps implemented in the drone in order to dynamically convert the attitude of the drone illustrated in FIG. 6; the sequence of steps will be executed iteratively until the conversion is complete. In other words, said sequence of steps is carried out for as long as the estimated pitch angle θₑₛₜ of the drone has not achieved the pitch angle θ_{ref}.

The sequence of steps begins with the step E10 of determining an angular trajectory and an anticipatory pre-command on the basis of the data regarding the speed of movement the drone in a reference point associated with the drone body, i.e. the horizontal speed of movement of the drone, from the estimated pitch angle θₑₛₜ of the drone and from the pitch angle to be achieved θ_{ref}.

Thus, the integrated navigation and attitude control system of the drone will determine, on the basis of a model of the dynamics of the drone:
an angular trajectory, i.e. a target trajectory in terms of angular acceleration and/or angular velocity and/or as an angle, corresponding to the set value given by the user and used as a reference by the integrated navigation and attitude control system of the drone, and
an anticipatory pre-command in order to execute said trajectory in an open loop, said pre-command being transmitted to the integrated navigation and attitude control system of the drone in order to anticipate the trajectory to be taken. Said anticipatory pre-command allows the moving drone to be oriented to the pitch inclination desired by the user, the integrated navigation and attitude control system of the drone neutralising disturbances relative to the trajectory depending on the current estimated pitch angle.

During steps E11 and E12 of the method, the integrated navigation and attitude control system of the drone will generate one or more differentiated commands on the basis of the determined angular trajectory, from the anticipatory pre-command and from the measurements coming from the inertial unit of the drone, and will transmit said commands to one or more propulsion units of the drone such that the drone is rotated about the pitch axis of the drone.

According to an embodiment, the current pitch angle θₑₛₜ of said drone is estimated on the basis of the measurement of the angular velocity of the drone.

Step E10 is followed by a step E11 of calculating the attitude set values on the basis of the determined angular trajectory, from the anticipatory pre-command and from the measurements coming from the inertial unit of the drone. To do this, step E11 comprises generating pitch angle set values.

Step E11 is followed by a step E12 of sending one or more determined differentiated commands to one or more of said propulsion units of the drone in accordance with the pitch angle set values that are generated. To do this, step E12 comprises applying said set values to a servo-control loop controlling the motors of the drone.

In parallel with managing the change in the attitude of the drone between the conventional flight position and the aircraft flight mode, the method also comprises determining the altitude of said drone and determining one or more differentiated commands on the basis of the altitude of the drone, in order to control the altitude of the drone during conversion, in particular to maintain the drone at the altitude thereof prior to executing the conversion instruction. Altitude management of the drone is carried out in particular at steps E13 to E15 described below.

Step E15, carried out in parallel with E10, for example, determines a trajectory in terms of altitude and vertical velocity and an anticipatory pre-command.

To do this, the current altitude of the drone is estimated, then on the basis of i) the estimated current altitude of the drone, ii) the estimated altitude of the drone prior to executing the conversion instruction and iii) the aerodynamic speed of movement of the drone, i.e. the horizontal speed of movement of the drone, the integrated navigation and attitude control system of the drone will determine, based on a model of the dynamics of the drone:

a trajectory in terms of altitude and vertical velocity corresponding to the information regarding the altitude of the drone that is determined before executing the conversion instruction and used as a reference by the integrated navigation and altitude control system of the drone and

an anticipatory pre-command in order to execute said trajectory in an open loop, said pre-command being transmitted to the integrated navigation and altitude control system of the drone in order to anticipate the trajectory to be taken. Said anticipatory pre-command allows the moving drone to be oriented on the determined trajectory, the integrated navigation and altitude control system of the drone neutralising disturbances relative to the trajectory.

Step E13 is followed by a step E14 of generating altitude set values on the basis of the determined trajectory in terms of altitude and vertical velocity, from the anticipatory pre-command and the measurements coming from the inertial unit of the drone. To do this, step E14 comprises generating altitude set values.

Step E13 may also take into account, if need be, a set value for the ascent speed added by the user to the above-mentioned altitude set value.

Step E14 is followed by a step E15 of sending one or more differentiated determined commands to one or more of said propulsion units of the drone depending on the altitude set values generated. To do this, step E15 comprises the applying said set values to a servo-control loop controlling the motors of the drone.

The method also comprises a step E16, carried out for example in parallel with steps E11 and E14, of compensating the equilibrium command of the drone according to the voltage of the battery, determined in particular during step E4.

In particular, the differentiated command/s generated by said method are also determined on the basis of the measured voltage of said battery unit.

According to a particular embodiment, the differentiated commands determined at steps E12 and E15, in order to control the propulsion units of the drone, may be merged before sending said commands to said propulsion units of the drone.

In order to determine the aerodynamic speed V of the drone, it is necessary first to determine the lift coefficient of the wings, in particular on the basis of the geometry thereof. According to a particular embodiment, thin airfoil theory is used. Said theory is principally valid when the drone flies with a roll angle of almost 90°. Said theory allows a velocity curve to be obtained for the different pitch angle values of the drone. The velocity values are slightly underestimated but still allow a good evaluation of the lift coefficient of the wings. The lift coefficient C_{L}, is defined as follows:

$${C}_{L} = + 2 π α \frac{Λ}{Λ + 2} , avec Λ = \frac{{b}^{2}}{S}$$

With b being the wing span of the wing, S the surface of the wing and α the angle of incidence.

It should be noted that C_{L}, is the lift coefficient at zero incidence, which has a value of 0 if the wing profile is symmetric.

The aerodynamic speed V of the drone is determined on the basis of the determined lift coefficient C_{L}, that is necessary to counterbalance the weight of the drone for each inclination at the pitch angle of the drone. To do this, the lift force L is determined according to the following formula:

L=½ρSV²C_{L}

ρ being the density of the air.

The aerodynamic speed V of the drone deduced therefrom is:

$$V = \sqrt{\frac{2 L}{ρ {SC}_{L}}}$$

Moreover, the drag coefficient Cx of the wings is determined using a symmetric-profile model known from the literature. For example, the drag coefficient Cx is determined according to the following formula:

Cx=2Fx/ρV²S

with Fx being the drag which is the aerodynamic component parallel to the airstreams of the relative wind,

ρ being the air density,

V being the aerodynamic speed of the drone determined previously,

S being the wing surface.

The drag coefficient varies according to the angle of incidence of the wings. The angle of incidence α is determined for example according to the pitch angle θ of said drone body. In particular, the angle of incidence α may be determined such that:

α=|θ|−90° i)

θ being defined as the nose-up angle of the drone, otherwise known as the pitch angle of the drone.

Thus, the drag coefficient will be determined for each pitch angle of the drone between 0° and 90°.

In order to achieve equilibrium in aircraft flight of the drone, the traction of the drone must counterbalance the aerodynamic drag Fx and the weight component of the drone on the heading axis in the reference point of the drone.

Thus, on the basis of the drag coefficient for each value of the pitch angle, the lift coefficient and the weight component of the drone, the set motor value to be applied that corresponds to the flight equilibrium command of the drone in aircraft flight mode is determined.

It should be noted that, according to the invention, the sending of one or more differentiated commands is executed after generating pitch angle set values corresponding to the angle of inclination to be implemented and applying said set values to a servo-control loop controlling the motors of the drone.

The angle set value is determined in the form of an ideal angular trajectory which the drone should follow and will be used as the set value by the integrated navigation and attitude control system of the drone. The command allowing said trajectory to be executed as an open loop comprises an anticipatory pre-command which completes the integrated navigation and attitude control system command, said anticipatory pre-command being determined on the basis of a servo-control loop taking into consideration the difference between the ideal trajectory that the drone should follow in accordance with the set value received and the trajectory said drone actually takes.

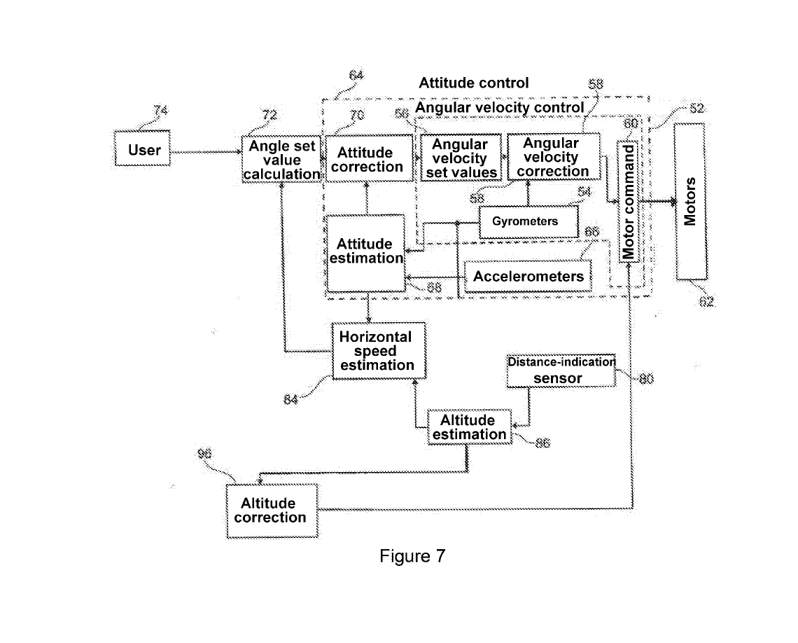

FIG. 7 is a functional block diagram of the different control and servo-control components of the drone. It should be noted however that, although said diagram is presented in the form of interconnected circuits, implementation of the different functions is essentially computer-based, and said diagram is simply illustrative.

The method for dynamically converting the attitude of a rotary-wing drone according to the invention brings into play a plurality of overlapping loops to control the angular velocity and attitude of the drone, and also to control the variations in altitude automatically.

The most central loop, which is the angular velocity control loop 52, uses on the one hand the signals supplied by the gyrometers 54, and on the other hand a reference made up of the angular velocity set values 56, these different items of information being applied as input to stage 58 of correcting the angular velocity. Said stage 58 controls a stage 60 which controls the motors 62 in order to separately control the rotational speed of the different motors in order to control the angular velocity of the drone by the combined action of the rotors driven by said motors.

The control loop 52 of the angular velocity overlaps with an attitude control loop 64, which operates on the basis of information supplied by the gyrometers 54 and the accelerometers 66, said data being applied as input to an attitude estimation stage 68, the output of which is applied to a PI (proportional-integral) attitude correction stage 70. Stage 70 delivers angular velocity set values to stage 56, which values are also a function of the angle set values generated by a circuit 72 from commands applied directly by the user 74, said angle set values being generated in accordance with the method for dynamically converting the altitude of a rotary-wing drone according to the invention.

On the basis of the error between the set value and the measurement of the angle given by the attitude estimation circuit 68, the attitude control loop 64 (circuits 54 to 70) calculates an angular velocity set value with the aid of the PI corrector of the circuit 70. The angular velocity control loop 52 (circuits 54 to 60) then calculates the difference between the preceding angular velocity set value and the angular velocity actually measured by the gyrometers 54. On the basis of this information, the loop calculates the different rotational speed set values to be sent to the motors 62 of the drone in order to produce the rotation requested by the user.

The horizontal velocity V is estimated by the circuit 84 on the basis of the information supplied by the attitude estimation circuit 68 and the altitude estimation given by the circuit 86, notably by means of an ultrasonic distance-indication sensor 80, and also a model. The estimation of the horizontal velocity V carried out by the circuit 84 is supplied to the circuit 72 for implementing the method for dynamically converting the altitude of the drone according to the invention.

What is claimed is:

1. A method for dynamically converting the attitude of a rotary-wing drone, comprising:
receiving a flight conversion instruction in a drone that includes a drone body comprising an electronic board controlling piloting of the drone, and four link arms forming lift-producing wings, each arm comprising a rigidly connected propulsion unit, the flight conversion instruction allowing the drone to effect a flight conversion between flight using the rotary wings and flight using, at least in part, the lift of the wings, said conversion being defined by a pitch angle to be achieved θ_{ref}, and,
executing, on reception the flight conversion instruction, a repeated sequence of steps until said pitch angle θ_{ref} is achieved, the steps comprising:
estimating the current pitch angle θₑₛₜ of said drone,
determining an angular trajectory depending on the pitch angle to be achieved θ_{ref},
sending one or more differentiated commands to one or more propulsion units such that the drone rotates about the pitch axis, which commands are servo-controlled to the angular trajectory and the current estimated pitch angle θₑₛₜ.

2. The method for dynamic control according to claim 1, wherein said conversion instruction comprises the pitch angle to be achieved θ_{ref}.

3. The method for dynamic control according to claim 1, wherein the angular trajectory is a target trajectory in terms of angular acceleration and/or angular velocity and/or angle.

4. The method for dynamic control according to claim 1, wherein the step of estimating the current pitch angle θₑₛₜ of said drone is effected on the basis of the measurement of the angular velocity of the drone.

5. The method for dynamic control according to claim 4, wherein the steps further comprise determining an anticipatory pre-command on the basis of the angular trajectory and the estimated current pitch angle.

6. The method for dynamic control according to claim 5, further comprising generating, on the basis of the angular trajectory that has been determined and the anticipatory pre-command, set values corresponding to an angular position at the given instant and applying said set values to a servo-control loop controlling the motors of the drone.

7. The method for dynamic control according to claim 6, wherein the set values are set values for the angle of inclination of the drone relative to the pitch angle thereof.

8. The method for dynamic control according to claim 1, wherein the steps further comprise:
determining the altitude of said drone prior to executing the conversion instruction,
estimating the current altitude of the drone,
determining a trajectory in terms of altitude and vertical velocity depending on the altitude prior to executing the conversion instruction, and,
sending one or more differentiated commands to one or more propulsion units so as to produce a correction in the altitude of the drone, servo-controlled to the trajectory in terms of altitude and vertical velocity and the estimated current altitude.

9. The method for dynamic control according to claim 1, wherein the steps further comprise measuring the voltage of a battery unit of the drone, wherein the one or more differentiated commands are further determined on the basis of the measured voltage of said battery unit.

10. The method for dynamic control according to claim 1, wherein the steps further comprise activating/deactivating at least one ultrasonic sensor of the drone.

11. The method for dynamic control according to claim 1, wherein the steps further comprise, prior to a flight conversion between flight using the rotary wings and flight using, at least in part, the lift of the wings, reducing the maximum angular velocity on the pitch axis and/or the maximum angular velocity on the roll axis.

12. The method for dynamic control according to claim 1, wherein the pitch angle to be achieved is substantially zero during a flight conversion between flight using, at least in part, the lift of the wings and flight using the rotary wing.

13. A rotary-wing drone comprising:
a drone body comprising an electronic board controlling the piloting of the drone, four link arms forming lift-producing wings, each arm comprising a rigidly connected propulsion unit, and,
program code executing in memory of the electronic board and performing the steps of:
receiving a flight conversion instruction in a drone that includes a drone body comprising an electronic board controlling piloting of the drone, and four link arms forming lift-producing wings, each arm comprising a rigidly connected propulsion unit, the flight conversion instruction allowing the drone to effect a flight conversion between flight using the rotary wings and flight using, at least in part, the lift of the wings, said conversion being defined by a pitch angle to be achieved θ_{ref}, and,
executing, on reception the flight conversion instruction, a repeated sequence of steps until said pitch angle θ_{ref} is achieved, the steps comprising:
estimating the current pitch angle θₑₛₜ of said drone,
determining an angular trajectory depending on the pitch angle to be achieved θ_{ref},
sending one or more differentiated commands to one or more propulsion units such that the drone rotates about the pitch axis, which commands are servo-controlled to the angular trajectory and the current estimated pitch angle θₑₛₜ.

14. An assembly comprising a control device for a rotary-wing drone and a rotary-wing drone comprising a drone body comprising an electronic board controlling the piloting of the drone, four link arms forming lift-producing wings, each arm comprising a rigidly connected propulsion unit, the control device comprising:
a set of piloting instructions including one conversion instruction to convert the flight of the drone in order to effect a conversion between rotary-wing flight and flight using the lift of the wings.

15. The assembly according to claim 14, wherein the conversion instruction comprises a pitch angle to be achieved θ_{ref}.
